(19) United States
(12) Patent Application Publication
(10) Pub. No.: US 2005/0109179 A1
(43) Pub. Date: May 26, 2005

(54) Cutting apparatus for severing a web

(75) Inventor: Richard Behringer, Utzenfeld (DE)

Correspondence Address: VENABLE, BAETJER, HOWARD AND CIVILETTI, LLP, P.O. BOX 34385, WASHINGTON, DC, 20043-9998, US

(73) Assignee: MULLER MARTINI HOLDING AG, Hergiswil (CH)

(21) Appl. No.: 10/967,920

(22) Filed: Oct. 19, 2004

(30) Foreign Application Priority Data
Oct. 20, 2003 (EP) 03405758.8

(51) Int. Cl. B23D 25/02

(52) U.S. Cl. 83/331

(57) ABSTRACT

A cutting apparatus for severing a web has a first moveable cutting blade, a second stationary cutting blade and a rotatable cutting cylinder, which has on its circumference at least one first cutting blade, wherein the first and second cutting blades each have at least one cutting edge, wherein the first cutting blade cooperates with the second stationary cutting blade to sever the web in a transverse direction and at least one of the first and second cutting blades is self-resilient.

### CROSS-REFERENCE TO RELATED APPLICATION

This application claims the priority of European Patent Application No. 03405758.8, filed on Oct. 20, 2003, the subject matter of which is incorporated herein by reference.

### BACKGROUND OF THE INVENTION

The invention relates to a cutting apparatus for severing a web and is of the type which has a rotatable cutting cylinder provided at a circumference thereof with at least one first cutting blade which cooperates with a stationary second cutting blade for severing the sheet material in a transverse direction.

A cutting apparatus of the above-outlined type is disclosed in the assignee's European Patent Document No. 1 186 561 A. The cutting apparatus serves for severing paper or film webs and has been proven in practice. The cutting cylinder is supported in side plates by tapered roller bearings. During cutting, heat is transmitted by the tapered roller bearings to the side plates, and as a consequence of the resulting heat expansion of the side plates, an increase of the distance between the two cutting blades occurs. As a rule, such a distance increase causes the cutting quality to deteriorate. By reducing the distance while the machine is warm, the distance can again be optimally set and thus the desired high cutting quality can be restored. This, however, has the disadvantage that at the beginning of the morning shift, when the cutting apparatus is restarted, a relatively large wear at both cutting blades occurs, since the distance has decreased due to the then cold machine. Heretofore this difficulty has been resolved by installing heatable bearings. Such heatable bearings, however, involve substantial expense and installing problems. Further, the heaters for pre-heating the lateral bearings have to be turned on hours before operation.

### SUMMARY OF THE INVENTION

It is an object of the invention to provide a cutting apparatus of the above-outlined type which avoids the discussed disadvantages and which thus makes possible a simplification of the maintenance and servicing, while ensuring a high cutting quality.

The above and other objects are accomplished according to the invention by the provision of a cutting apparatus for severing a web, comprising: a first moveable cutting blade; a second stationary cutting blade; and a rotatable cutting cylinder which has on its circumference at least one first cutting blade; wherein the first and second cutting blades each have at least one cutting edge, the first cutting blade cooperates with the second stationary cutting blade to sever the web in a transverse direction and at least one of the first and second cutting blades is self-resilient.

Thus, according to the invention, the above-described conventional cutting apparatus is improved in that at least one of the two cutting blades are self-resilient. In the cutting apparatus according to the invention the self-resilient cutting blade essentially works like a spring during the cutting operation and therefore such a self-resilient cutting blade is significantly more tolerant as concerns distance variations between the two cutting blades. While the self-resilient cutting blade cuts with the required high quality when the cutting apparatus is warm, in case of a cold cutting apparatus and thus at reduced distance between the cutting blades, the latter are not worn out in a short period of time and thus a high cutting quality may be obtained.

According to an advantageous feature of the invention it is the stationary cutting blade which is self-resilient. Basically, however, the cutting blade mounted on the cutting cylinder may also be self-resilient.

According to a further feature of the invention, the self-resilient cutting blade has at least one opening which, in accordance with a further feature of the invention, is a slot extending at least approximately parallel to one cutting edge into which the self-resilient cutting blade may resiliently penetrate. The slot is preferably so structured that it extends between the two cutting edges. It is a particular advantage of this construction that the self-resilient cutting blade may be particularly simply re-sharpened, since two surfaces forming cutting edges lie in one plane. One of such surfaces may be used, with one of the bordering abutment surface, for positioning the self-resilient cutting blade, while the other cutting edge is active. By inverting the cutting blade the cutting edges may be exchanged.

According to a further embodiment of the invention, the self-resilient cutting blade has two slots, each arranged between two cutting edges which resiliently penetrate into the common slot. In such a cutting apparatus the self-resilient cutting blade has four cutting edges which may be exchanged by inverting the cutting blade. For this purpose only two cutting edge-forming surfaces are required and, accordingly, re-sharpening is relatively simple. For this embodiment too, it is provided that an inactive cutting edge lies against an abutment surface and thus positions the self-resilient cutting blade.

According to a further feature of the invention, on the self-resilient cutting blade a cover bar is disposed which has a frontal edge extending essentially parallel to and spaced from, a cutting edge. By means of the cover bar the active cutting edge and thus the resilient region of the cutting blade may be stabilized. The cover bar is preferably shiftable, so that undesired oscillations of the resilient region of the cutting blade are effectively prevented.

According to a further feature of the invention, the self-resilient cutting blade is staggered. This arrangement provides for a resilient region supported in a free-standing manner. In such a construction the self-resilient cutting blade preferably has two cutting edges which may be exchanged.

According to a further feature of the invention, the self-resilient cutting blade is relatively thin at least in the region of an active cutting edge and is supported in a free-standing manner in such a region. Such a cutting blade preferably has four cutting edges.

### BRIEF DESCRIPTION OF THE DRAWINGS

Further advantageous features appear in the dependent claims, the specification which follows and the drawing.

Several embodiments of the invention will be discussed in more detail in the following specification in conjunction with the drawing, wherein:

FIG. 1 is a schematic view of a cutting apparatus according to the invention,

FIG. 2 is an enlarged detailed schematic of FIG. 1,

FIG. 3 is a detailed schematic of a variation of the cutting apparatus according to the invention and

FIG. 4 is a detailed schematic of an additional variation of the cutting apparatus according to the invention.

### DETAILED DESCRIPTION OF THE INVENTION

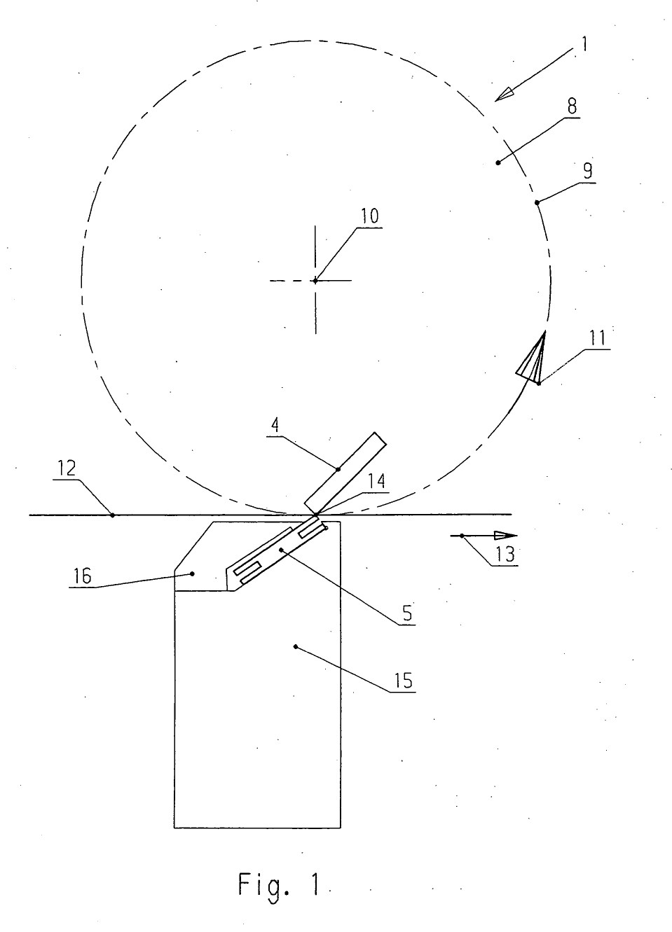

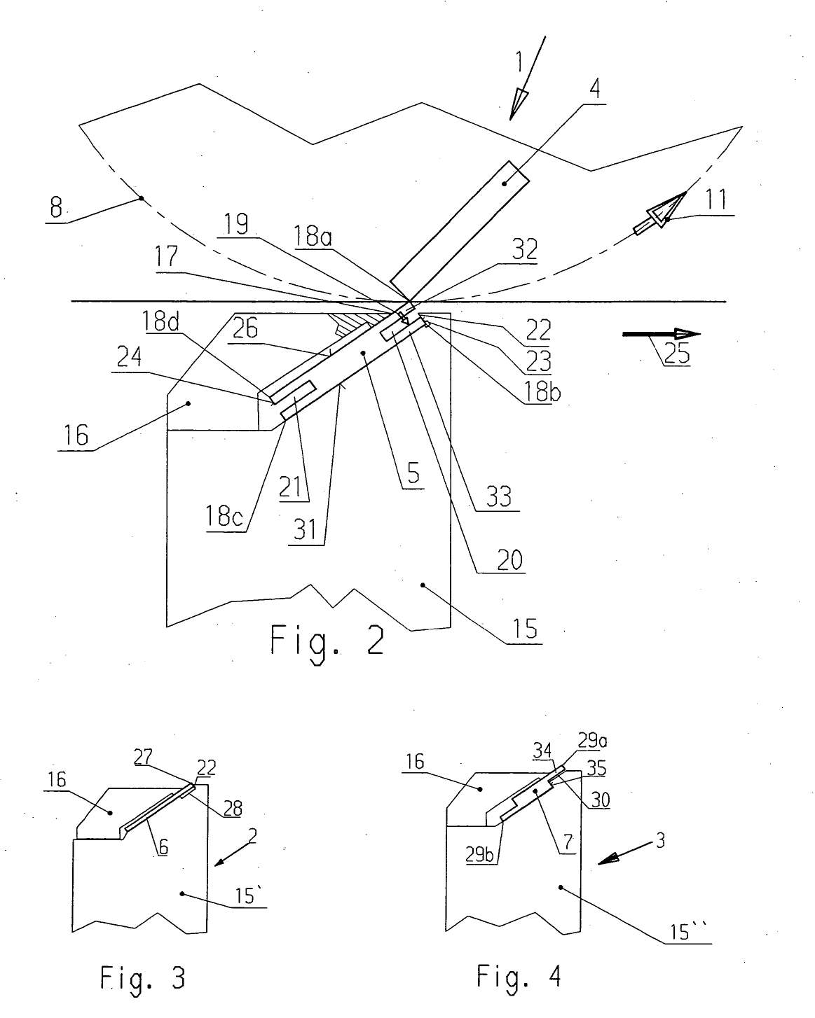

The cutting apparatus 1 illustrated in FIGS. 1 and 2 serves for severing an endless web 12, particularly a paper web, into uniform portions. Feeding of the web 12 occurs continuously in the direction of arrow 13 by pushing and pulling. Means for feeding the web 12 is well known to those skilled in the art and need therefore not be discussed in further detail. The web 12 is thus advanced from the left to the right in the direction of the arrow 25.

For the purpose of severing the web 12 transversely to the feeding direction, the cutting apparatus 1 includes a cutting cylinder 8 which is continuously rotated in the direction of the arrow 11 about a rotary axis 10. The drive for rotating the cutting cylinder 8 as well as the side plates and bearings for the cutting cylinder 8 are known by themselves and are not shown.

On a circumference 9 of the cutting cylinder 8 at least one bar-shaped cutting blade 4 is mounted which has at least one cutting edge 14, having a length that at least equals the width of the web 12. Such width is, for example, in the range of from 520 mm to 740 mm. The cutting cylinder 8 has at least one cutting blade 4, but it may have several such cutting blades 4, so that relatively narrow strips may also be severed from the web 12.

The cutting blade 4 cooperates with a likewise bar-shaped cutting blade 5 which is affixed to a carrier 15. For positioning the cutting blade 5 on the carrier 15, the latter has an abutment surface 22 against which the cutting blade 5 lies with a surface 23. Further, the cutting blade 5 engages face-to-face a surface 31 of the carrier 15.

The cutting blade 5 is provided with two slots 20 and 21 which extend preferably over the entire length of the bar-shaped cutting blade 5 and which are both open at their end. The slot 20 is situated essentially centrally between an active cutting edge 18a and an inactive cutting edge 18b. The slot 20 forms two regions 32 and 33 which are relatively thin-walled and which may be resiliently deflected. The region 33 is inactive (quieted) as shown in FIG. 2, while the region 32 may be deflected toward the slot 20. In case the cutting blade 4 hits the cutting edge 18a, the latter may resiliently penetrate into the slot 20 in the direction of the arrow 19. The deflection in the direction of the arrow 19 is, to be sure, relatively small and amounts to a few hundreds of one mm. The cutting blade 5 may be inverted to situate the cutting edge 18a in the region of the abutment surface 22, thus rendering it inactive, while the cutting edge 18b will be active.

The cutting blade 5 has a further slot 21 as well as two further cutting edges 18c and 18d. Thus, the cutting blade 5 has a total of four cutting edges 18a, 18b, 18c and 18d. All cutting edges may be exchanged. Re-sharpening is performed at the surfaces 23 and 24, so that simultaneously two cutting edges may be sharpened.

The cutting blade 5 has a planar surface 26 oriented parallel to the surface 31 of the carrier 15. A cover bar 16 lies against the cutting blade 5 at the surface 26 and in the vicinity of the cutting edge 18a. A frontal edge 17 of the cover bar 16 extends parallel to the cutting edge 18a. By means of the cover bar 16 the resilient region 32 is stabilized and thus undesired oscillations of the region 32 are prevented. The cover bar 16 is preferably shiftable for adjusting the distance of the edge 17 from the cutting edge 18a. Such a construction ensures an optimal support of the resilient region 32.

While as a rule, the two cutting blades 4 and 5 and thus the cutting edges 14 and 18a do not extend axially parallel, it is feasible to arrange them in an axially parallel manner.

The cutting blade 5 is, in view of the above-described construction, self-resilient, and it is thus ensured that the cutting blade 5 behaves as a spring and is significantly more tolerant to distance variations. Thus, if the axis 10 moves upward or downward due to temperature changes at the side plates, such distance variations may be taken up by the cutting edge 18a by a resilient deflection thereof without an appreciable additional wear and without a deterioration of the cutting quality. In this manner the service life of the cutting blade 5 may be substantially extended.

In the cutting apparatus 1 the cutting blade 5 is of self-resilient construction. In the alternative, it is basically feasible to design the cutting blade 4 as being self-resilient and the cutting blade 5 as being rigid. Further, basically an embodiment is feasible where both cutting blades 4 and 5 are self-resilient.

FIG. 3 illustrates a part of a cutting apparatus 2 showing a variant of the invention. In this embodiment a self-resilient cutting blade 6 is supported on a carrier 15′ which has, in the region of a cutting edge 27, an aperture 28 permitting a deflection of the cutting edge 27. The cutting blade 6, which is relatively thin, thus making possible a resilient deflection thereof, is positioned on the abutment surface 22. Therefore, upon deflection, the cutting blade 6 rubs against the abutment surface 22.

FIG. 4 illustrates a part of a cutting apparatus 3 showing a further variant of the invention. In this embodiment a self-resilient cutting blade 7 is provided which is supported on a carrier 15″. The cutting blade 7 is of staggered design and has an active cutting edge 29a and an inactive (quieted) cutting edge 29b. Between a resilient region 34 and the carrier 15″ a gap-like intermediate space 30 is provided which makes possible a deflection of the resilient region 34 during cutting. Similarly to the earlier-described embodiments, in the cutting apparatus 3 too, a cover bar 16 is provided. In this embodiment the cutting blade 7 has only two exchangeable cutting edges 29a and 29b. The positioning of the cutting blade 7 is effected at an abutment surface 35.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A cutting apparatus for severing a web, comprising:
a first moveable cutting blade;
a second stationary cutting blade; and
a rotatable cutting cylinder which has on its circumference at least one first cutting blade;
wherein the first and second cutting blades each have at least one cutting edge, the first cutting blade cooperates with the second stationary cutting blade to sever the web in a transverse direction and at least one of the first and second cutting blades is self-resilient.

2. The cutting apparatus as defined in claim 1, wherein the second stationary cutting blade is self-resilient.

3. The cutting apparatus as defined in claim 1, wherein the self-resilient cutting blade has at least one opening.

4. The cutting apparatus as defined in claim 3, wherein the opening extends parallel to at least one cutting edge, which cutting edge may resiliently penetrate into said opening.

5. The cutting apparatus as defined in claim 4, wherein the self-resilient cutting blade further comprises two slots, one at each end of the blade, spaced from one another, wherein each slot separates two cutting edges which two edges can resiliently penetrate into the slot during the cutting operation.

6. The cutting apparatus as defined in claim 1, further comprises a carrier for receiving the self-resilient cutting blade and having a surface which abuts a cutting edge rendering the edge inactive, wherein the self-resilient cutting blade further comprises four mutually spaced cutting edges and is positioned in the carrier so that one edge contacts the abutment surface.

7. The cutting apparatus as defined in claim 1, further comprises a cover bar, having a frontal edge, positioned on the cutting blade so that the frontal edge extends parallel to and spaced from, an active cutting edge of the cutting blade.

8. The cutting apparatus as defined in claim 7, wherein the position of cover bar can be shifted.

9. The cutting apparatus as defined in claim 1, wherein the self-resilient cutting blade is staggered.

10. The cutting apparatus as defined in claim 1, wherein the self-resilient cutting blade has a relatively thin cutting edge, which is free-standing.
